(19) United States
(12) Patent Application Publication
(10) Pub. No.: US 2026/0284612 A1
(43) Pub. Date: Sep. 24, 2026

(54) PROCESS FOR MIXING A FLUID MELTFLOW STREAM

(71) Applicant: Dow Global Technologies LLC, Midland, MI (US)

(72) Inventors: Saurav S. Sengupta, Gilbertsville, PA (US); Mohammad Arif Hossain, Lake Jackson, TX (US); Irfan Khan, Houston, TX (US); Mohamed Esseghir, Lawrenceville, NJ (US); Michael J. Parker, Philadelphia, PA (US); Andreas Imthurn, Pearland, TX (US)

(21) Appl. No.: 19/469,019

(22) PCT Filed: Mar. 8, 2024
(86) PCT No.: PCT/US2024/019117

§ 371 Date: Sep. 25, 2025

Related U.S. Application Data
(60) Provisional application No. 63/494,625, filed on Apr. 6, 2023.

(51) Int. Cl. B01F 25/62; B01F 23/40; B01F 23/451; B01F 23/47; B01F 25/00; B01F 25/314; B01F 101/00; B29B 7/42

(52) U.S. Cl. CPC B01F 25/62; B01F 23/451; B01F 23/47; B01F 23/482; B01F 25/3141; B29B 7/422; B01F 2025/913; B01F 2101/2805

(57) ABSTRACT

The present disclosure provides a process. In an embodiment, the process includes providing an apparatus. The apparatus includes (A) a passageway with an interior for receiving a first flow stream (FFS1), the passageway having an inflow end and an opposing outflow end, and (B) a gear pump assembly. The gear pump assembly includes (i) a housing, (ii) a gear chamber in the housing, (iii) an inlet placing the passageway outflow end in fluid communication with the gear chamber, the inlet having a width (I_{w}), (iv) a plurality of intermeshing gears mounted for rotation in the gear chamber, the gears having teeth which engage with each other in the chamber, each gear having an axis of rotation, and (v) an outlet in fluid communication with the gear chamber. The apparatus includes (C) one or more injectors upstream of the gear pump assembly for adding a second fluid into the first flow stream. The injectors are located a distance of at least one-half of a gear diameter upstream of the inlet. Each injector has an elongated conduit extending into the passageway interior. Each elongated conduit is substantially parallel to the gear axis of rotation. The process includes introducing the second fluid from each respective elongated conduit into the FFS1 at a location at least one-half of a gear diameter upstream of the inlet, and feeding the FFS1 and the second fluid into the inlet. The process includes mixing, in the gear chamber, the second fluid with FFS1 to form a mixed fluid flowstream (mFFS); and discharging the mFFS from the outlet.

### BACKGROUND

Extruders and static mixers are commonly used to combine, or otherwise mix, two or more viscous materials such as polymer melt streams. A polymer melt stream is generally highly viscous and the flow of the polymer melt stream in the process is typically laminar with no natural mixing mechanism. The highly viscous nature of polymer melt streams makes the addition and mixing of small amounts of low viscosity fluid products (additive) problematic. Although an extruder (either twin-screw or single screw), can be used to mix a lower viscosity liquid additive into a polymer melt stream, extruders are difficult to scale-up, and production costs increase rapidly when increased production capacity and increased extruder size is desired.

Employing a static mixer carries the disadvantage of increasing capital costs. A static mixer impedes flow and correspondingly poses the risk of introducing significant pressure drop into a polymer melt flow production process. Pressure drop resulting from addition of a static mixer into a flow process can lead to potential dead zones in the production flowstream. Dead zones can lead to long term degradation of the polymer melt stream flow process.

The art recognizes the need for alternative mixing processes for polymer melt streams that avoid extruders and/or static mixers.

### SUMMARY

The present disclosure provides a process. In an embodiment, the process includes providing an apparatus. The apparatus includes (A) a passageway with an interior for receiving a first flow stream (FFS1), the passageway having an inflow end and an opposing outflow end, and (B) a gear pump assembly. The gear pump assembly includes (i) a housing, (ii) a gear chamber in the housing, (iii) an inlet placing the passageway outflow end in fluid communication with the gear chamber, the inlet having a width (I_{w}), (iv) a plurality of intermeshing gears mounted for rotation in the gear chamber, the gears having teeth which engage with each other in the chamber, each gear having an axis of rotation, and (v) an outlet in fluid communication with the gear chamber. The apparatus includes (C) one or more injectors upstream of the gear pump assembly for adding a second fluid into the first flow stream. The injectors are located a distance of at least one-half of a gear diameter upstream of the inlet. Each injector has an elongated conduit extending into the passageway interior. Each elongated conduit is substantially parallel to the gear axis of rotation. The process includes introducing the second fluid from each respective elongated conduit into the FFS1 at a location at least one-half of a gear diameter upstream of the inlet, and feeding the FFS1 and the second fluid into the inlet. The process includes mixing, in the gear chamber, the second fluid with FFS1 to form a mixed fluid flowstream (mFFS); and discharging the mFFS from the outlet.

### BRIEF DESCRIPTION OF THE DRAWINGS

FIG. 1 is a sectional view of an apparatus with a gear pump in accordance with an embodiment of the present disclosure.

FIG. 2 is an enlarged view of Area 2 of FIG. 1.

FIG. 3A is a breakaway perspective view of the apparatus of FIG. 1 showing fluidsheets in accordance with an embodiment of the present disclosure.

FIG. 3B is top plan view of Area 3B of FIG. 3A.

FIG. 3C is a sectional view taken along line 3C-3C of FIG. 3A.

FIG. 3D is a sectional view taken along line 3C-3C of FIG. 3A.

FIG. 4A is a sectional view of the apparatus of FIG. 1 indicating alternate locations for injectors in the passageway of the apparatus.

FIGS. 4B-4E are cross-sectional views of the apparatus showing flow and mixing profiles corresponding to the injector locations in FIG. 4A. FIGS. 4B-4E also show a cross-sectional view of the resultant mixed fluid flowstream and the corresponding the CoV value for each respective flow and mixing profile.

FIG. 5 is a side elevational view of an apparatus with a tapered section in accordance with an embodiment of the present disclosure.

FIG. 6A is a front elevational view of an injection conduit in a vertical orientation in accordance with an embodiment of the present disclosure.

FIG. 6B is a front elevational view of an injection conduit in a horizontal orientation in accordance with an embodiment of the present disclosure.

FIGS. 7A, 7B, and 7C each is a perspective view of intermeshing gears in accordance with respective embodiments of the present disclosure.

### DEFINITIONS

Any reference to the Periodic Table of Elements is that as published by CRC Press, Inc., 1990-1991. Reference to a group of elements in this table is by the new notation for numbering groups.

For purposes of United States patent practice, the contents of any referenced patent, patent application or publication are incorporated by reference in their entirety (or its equivalent U.S. version is so incorporated by reference) especially with respect to the disclosure of definitions (to the extent not inconsistent with any definitions specifically provided in this disclosure).

The numerical ranges disclosed herein include all values from, and including, the lower and upper value. For ranges containing explicit values (e.g., from 1 or 2, or 3 to 5, or 6, or 7), any subrange between any two explicit values is included (e.g., the range 1-7 above includes subranges of from 1 to 2; from 2 to 6; from 5 to 7; from 3 to 7; from 5 to 6; etc.).

Unless stated to the contrary, implicit from the context, or customary in the art, all parts and percents are based on weight and all test methods are current as of the filing date of this disclosure.

The terms “blend” or “polymer blend,” as used, refers to a mixture of two or more polymers. A blend may or may not be miscible (not phase separated at molecular level). A blend may or may not be phase separated. A blend may or may not contain one or more domain configurations, as determined from transmission electron spectroscopy, light scattering, x-ray scattering, and other methods known in the art. The blend may be affected by physically mixing the two or more polymers on the macro level (for example, melt blending resins or compounding), or the micro level (for example, simultaneous forming within the same reactor).

The term “composition” refers to a mixture of materials which comprise the composition, as well as reaction products and decomposition products formed from the materials of the composition.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination.

Ethylene-based polymer (interchangeably referred to as polyethylene) is a polymer comprising a majority amount (>50 mol %) of units which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); single-site catalyzed, Linear Low Density Polyethylene, including both linear and substantially linear low density resins (m-LLDPE); ethylene-based plastomers (POP) and ethylene-based elastomers (POE); Medium Density Polyethylene (MDPE); and High Density Polyethylene (HDPE). These polyethylene materials are generally known in the art; however, the following descriptions may be helpful in understanding the differences between some of these different polyethylene resins.

The term “LDPE” may also be referred to as “high pressure ethylene polymer” or “highly branched polyethylene” and is defined to mean that the polymer is partly or entirely homo-polymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 to 0.935 g/cm³.

The term “LLDPE”, includes both resin made using the traditional Ziegler-Natta catalyst systems and chromium-based catalyst systems as well as single-site catalysts, including, but not limited to, substituted mono- or bis-cyclopentadienyl catalysts (typically referred to as metallocene), constrained geometry catalysts, pyridylamine catalysts, phosphinimine catalysts & polyvalent aryloxyether catalysts (typically referred to as bisphenyl phenoxy), and includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or U.S. Pat. No. 5,854,045). The LLDPEs can be made via gas-phase, solution-phase or slurry polymerization or any combination thereof, using any type of reactor or reactor configuration known in the art.

The term “MDPE” refers to polyethylenes having densities from 0.926 to 0.935 g/cm³. “MDPE” is typically made using chromium or Ziegler-Natta catalysts or using single-site catalysts including, but not limited to, substituted mono- or bis-cyclopentadienyl catalysts (typically referred to as metallocene), constrained geometry catalysts, pyridylamine catalysts, phosphinimine catalysts & polyvalent aryloxyether catalysts (typically referred to as bisphenyl phenoxy), and typically have a molecular weight distribution (“MWD”) greater than 2.5.

The term “HDPE” refers to polyethylenes having densities greater than about 0.935 g/cm³ and up to about 0.980 g/cm³, which are generally prepared with Ziegler-Natta catalysts, chrome catalysts or single-site catalysts including, but not limited to, substituted mono- or bis-cyclopentadienyl catalysts (typically referred to as metallocene), constrained geometry catalysts, pyridylamine catalysts, phosphinimine catalysts & polyvalent aryloxyether catalysts (typically referred to as bisphenyl phenoxy).

The term “ULDPE” refers to polyethylenes having densities of 0.855 to 0.912 g/cm³, which are generally prepared with Ziegler-Natta catalysts, chrome catalysts, or single-site catalysts including, but not limited to, substituted mono- or bis-cyclopentadienyl catalysts (typically referred to as metallocene), constrained geometry catalysts, pyridylamine catalysts, phosphinimine catalysts & polyvalent aryloxyether catalysts (typically referred to as bisphenyl phenoxy). ULDPEs include, but are not limited to, polyethylene (ethylene-based) plastomers and polyethylene (ethylene-based) elastomers. Polyethylene (ethylene-based) elastomers plastomers generally have densities of 0.855 to 0.912 g/cm³.

An “olefin” is an unsaturated, aliphatic hydrocarbon having a carbon-carbon double bond.

An “olefin-based polymer” (interchangeably referred to as “polyolefin”) is a polymer that contains a majority weight percent of polymerized olefin monomer (based on the total amount of polymerizable monomers), and optionally, may contain at least one comonomer. Nonlimiting examples of olefin-based polymer include ethylene-based polymer and propylene-based polymer

The term “polymer” or a “polymeric material,” as used herein, refers to a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

A “propylene-based polymer” (interchangeably referred to as “polypropylene”) is a polymer that contains more than 50 mole percent polymerized propylene monomer (based on the total amount of polymerizable monomers) and, optionally, may contain at least one comonomer. Propylene-based polymer includes propylene homopolymer, and propylene copolymer (meaning units derived from propylene and one or more comonomers). The terms “propylene-based polymer” and “polypropylene” may be used interchangeably. A nonlimiting example of a propylene-based polymer (polypropylene) is a propylene/α-olefin copolymer with at least one C₂ or C₄-C₁₀ α-olefin comonomer.

### Test Methods

Degree of mixing. The degree of mixing is quantified by the coefficient of variance (CoV) of the local concentration of second fluid (F2) relative to the first flow stream (FFS1) on a certain cross-sectional plane. The CoV defined in Equation 1, is calculated on a cross-sectional plane normal to the average flow velocity, where C is the concentration at position r and time t and C̅ is the mean concentration.

$$CoV = \frac{σ}{\overline{C}} \qquad Equation 1$$

$$\overline{C} = Mean concentration = \frac{1}{n} {\sum }_{i = 1}^{n} {C}_{i} \qquad Equation 2$$

$$σ = Standard deviation = \sqrt{\frac{{\sum }_{i = 1}^{n} {( {C}_{i} - \overline{C} )}^{2}}{n - 1}} \qquad Equation 3$$

wherein n is the sample size, which is the number of computational fluid dynamics fluid elements in the cross-sectional plane and Cᵢ is the concentration in the ith fluid element. In general, the lower the CoV value, the higher degree of mixing.

Density is measured in accordance with ASTM D792, Method B. The result is recorded in grams (g) per cubic centimeter (g/cc or g/cm³).

Density for fluid flowstream is measured in accordance with ASTM D792, Method B. The result is recorded in grams (g) per cubic centimeter (g/cc or g/cm³).

Melt index (I₂ or MI) is measured in accordance with ASTM D-1238 at 190° C. at 2.16 kg. The values are reported in g/10 min, which corresponds to grams eluted per 10 minutes

“Viscosity” refers to the resistance of a fluid which is being deformed by either sheer stress or tensile stress. For purposes of this specification, viscosity is measured at 130° C. using a Brookfield viscometer as measured in accordance with ASTM D 445. Results are reported in centipoise, cP.

### DETAILED DESCRIPTION

The present disclosure provides a process. In an embodiment, the process includes providing an apparatus. The apparatus includes (A) a passageway with an interior for receiving a first flow stream (FFS1). The passageway has an opening at an inflow end and an opening at an opposing outflow end. The apparatus includes (B) a gear pump assembly. The gear pump assembly includes (i) a housing, (ii) a gear chamber in the housing, (iii) an inlet placing the passageway in fluid communication with the gear chamber, the inlet having a width (I_{w}), (iv) a plurality of intermeshing gears mounted for rotation in the gear chamber, the gears having teeth which engage with each other in the chamber, each gear having an axis of rotation, and (v) an outlet in fluid communication with the gear chamber. The apparatus includes (C) one or more injectors located upstream of the gear pump assembly for adding a second fluid into the first flowstream. Each injector is located the distance of at least at least one-half of a gear diameter upstream of the inlet. Each injector has an elongated conduit extending into the passageway interior, each elongated conduit is substantially parallel to, or is parallel to, the gear axis of rotation. The process includes introducing a second fluid from each respective elongated conduit into the FFS1 at a location at least one-half of a gear diameter upstream of the inlet. The process includes feeding the FFS1 and the second fluid into the inlet, mixing, in the gear chamber, the second fluid with FFS1 to form a mixed fluid flowstream (mFFS), and discharging the mFFS from the outlet.

Description is hereby provided with particular reference to the accompanying drawings, which illustrate the features and operation of embodiments of the present disclosure, but which are not intended to limit scope. In the Figures (unless otherwise indicated), like numerals are used throughout to designate like elements of the apparatus.

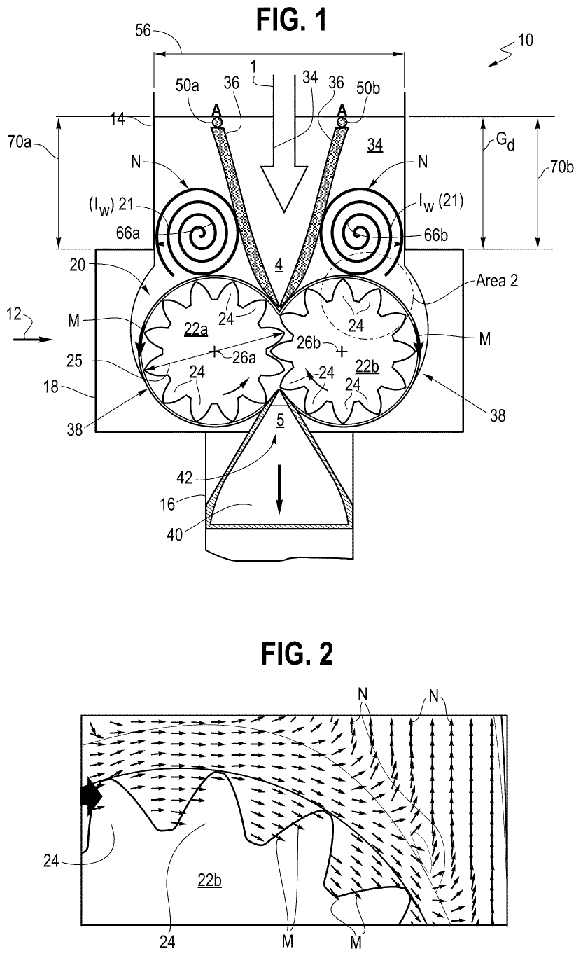

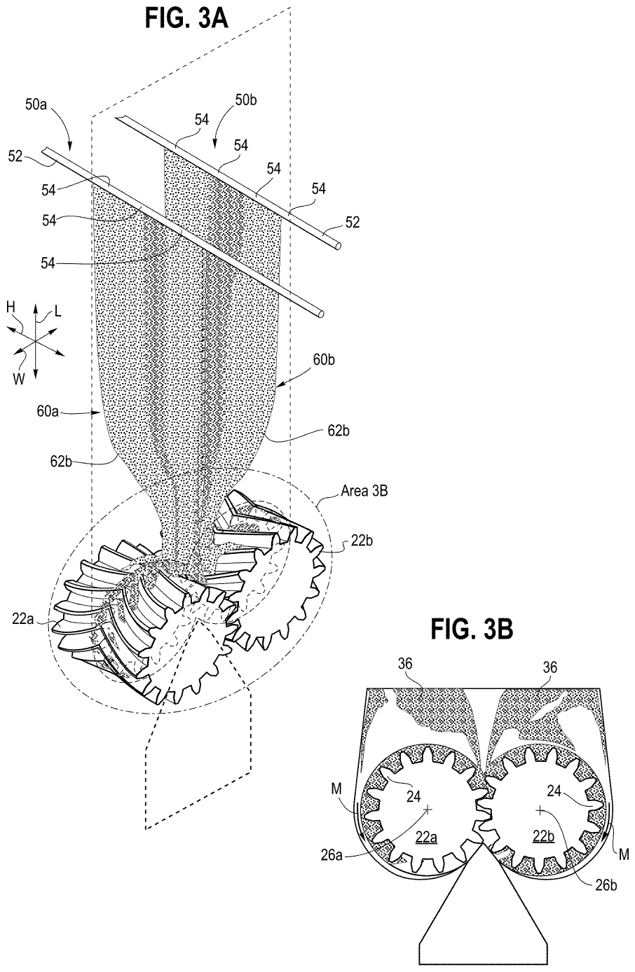

FIGS. 1 and 2 illustrate a mixing apparatus 10 having a gear pump 12, a passageway 14, and an outlet barrel 16. Passageway 14 is an annular body having a substantially uniform diameter, or a uniform diameter, along the length thereof. Passageway 14 may or may not include a tapered section 15 as will be disclosed below. When the tapered section is not present, passageway 14 has a substantially uniform diameter, or a uniform diameter, along the length of passageway 14.

Apparatus 10 includes a gear pump assembly. A “gear pump” is a positive displacement pump that moves a fluid (or one or more fluids) by repeatedly enclosing a fixed volume using intermeshing gears in a housing, the intermeshing gears transferring the fluid mechanically using a cyclic pumping action. The rotating gears develop a liquid seal with the pump housing and create suction at the pump inlet. Fluid drawn into the pump, is enclosed within the cavities of the rotating gears and the fluid is transferred to a discharge outlet.

FIG. 1 is a sectional view of apparatus 10. FIG. 1 shows gear pump assembly 12.

Gear pump assembly 12 includes a housing 18 which defines a gear chamber 20. Gear chamber 20 has an inlet 19. Inlet 19 is an opening in housing 18 which places passageway 14 in fluid communication with gear chamber 20. Inlet 19 has an inlet width 21. Inlet width 21 is the longest length of inlet 19 that extends between opposing sides of housing 18. When the top-to-bottom length of inlet 19 is not the same length as the side-to-side length for inlet 19, inlet width 21 is the length that is the larger of the top-to-bottom length or the side-to-side length. When inlet 19 has a circular cross-sectional shape, inlet width 21 is the diameter of inlet 19. As the configuration and shape of inlet 19 may vary, the length of inlet width 21 may vary correspondingly. In other words, inlet width 21 may or may not include the aggregate of the diameters for intermeshed gears 22a and, 22b, in addition to the small clearance, or small gap, between each gear an inner wall of gear chamber 20. The length, or extent, of inlet width 21 is interchangeably referred to as “I_{w}.”

Within gear chamber 20 resides a plurality of (or two) intermeshing gears (interchangeably referred as gears, or gear (singular)), gear 22a and gear 22b. Each gear 22a, 22b has teeth 24. The teeth 24 of gear 22a intermesh with (or interlock with) the teeth 24 of gear 22b. In an embodiment, gear 22a is the same size and the same shape as gear 22b such that gear 22a and gear 22b each have a gear diameter 25, that is the same length. The “gear diameter,” as used herein, is the length of a straight line segment that begins from one gear tooth, passes through the axis of rotation, and extends across the gear to an opposing gear tooth, as shown by gear diameter 25, gear diameter 25 being a straight line segment shown in FIG. 1. Gear diameter 25 is interchangeably referred to as “G_{d}.”.” The term “gear diameter” is interchangeably referred to as “gear outer diameter” and/or “pitch diameter.” Alternatively, gear 22a may have a size and/or a shape that is different than the size and shape of gear 22b. Each gear 22a, 22b is supported by a separated shaft (not shown). Generally, one gear is driven by a motor and this drives the other gear (the idler). In an embodiment, both shafts may be driven by motors. The shafts are supported by bearings on each side of the casing. Each shaft rotates a respective gear about an axis of rotation. Gear 22a rotates about axis of rotation 26a, gear 22b rotates about axis of rotation 26b. As each gear 22a, 22b rotates about its respective axis of rotation, teeth 24 mate, intermesh, engage, or otherwise interengage with each other. As rotation of the gears continue the teeth disengage from each other.

In an embodiment, each gear has a helix angle. A “helix angle,” as used herein, is the angle between the axis of rotation of the gear and a line tangent to one of the teeth, from an an elevational view of the gear. The helix angle can be from 0° to 45°. In a further embodiment, the helix angle for the gears 22a, 22b is from 0° to 5°.

In an embodiment, each gear is a herringbone gear. A “herringbone gear” is a gear having a helix angle alpha from one end of the gear cylinder to the middle of the gear-cylinder and then an angle 360−alpha from the middle of the gear-cylinder to the other end of the gear-cylinder. The angle is measured from the edge of the helical gear-teeth to the axis of the gear-cylinder moving in the clockwise direction. This creates a “V-pattern” for the gear-teeth on the gear-cylinder and therefore the name “Herring (fish)-bone,” or “herringbone.”

The process includes feeding a first fluid flowstream 34 (shaded grey area in FIG. 1) into passageway 14. Passageway 14 has an upstream, or inflow, end for receiving the first fluid flowstream. Passageway 14 has a downstream, or outflow, end in fluid communication with inlet 19. A “fluid flowstream,” as used herein, is a material that is in a fluid state and moves, or otherwise flows, as a stream. Fluid flow is distinct from fine solid particle flow (pouring of sand, for example) because the fine solid particles (sand particles) are not in a fluid state. Flow is typically induced and sustained by gravity, but other forms of energy or force can be used to induce flow, e.g., that resulting from the use of a pump. Nonlimiting examples of first fluid flowstream (interchangeably referred to as “FFS1”) material include polymer in a melted, molten or otherwise flowable state including, polyester, polyamide, polyurethane, polyolefin (polyethylene, polypropylene), poly(ethylene terephthalate), natural rubber, synthetic rubber, EPDM, and combinations thereof. In an embodiment, the FFS1 has a viscosity from 0.1 g/10 min to 1000 g/10 min, or from 0.1 g/10 min to 100 g/10 min, or from 0.1 g/10 min to 10 g/10 min. Apparatus 10 includes one or more injectors 50 for introducing a second fluid into FFS1. Apparatus 10 may include one, or two, or three, or four, or five, or six, or more injectors 50. Injectors 50 are located upstream of gear pump assembly 12. Injectors 50 are in fluid communication with a source for the second fluid, along with tubing, valve(s), and pump(s) for supplying the second fluid to injectors 50. Nonlimiting examples of suitable materials for the second fluid (interchangeably referred to as “F2”) include colorant, a pigment, a carbon black, crosslinking agent, free radical initiator (peroxide) a glass fiber, an impact modifier, an antioxidant, a surface lubricant, a UV light absorbing agent, a metal deactivator, filler, a nucleating agent, a stabilizer, a flame retardant, and combinations thereof. It is understood F2 is a fluid and may or may not include solid particles dispersed therein, F2 having a viscosity less than the viscosity of FF1. In an embodiment, the second fluid has a viscosity that is less than the viscosity of the FFS1. In a further embodiment, the second fluid has a viscosity from 1 centiPoise (cP) to 5000 cP.

In an embodiment, each injector 50 includes an elongated conduit 52 that extends, penetrates, or otherwise transverses the interior of passageway 14. Each elongated conduit 52 transverses, a portion of, or the entire diameter of, passageway 14, each elongated conduit 52 extending across the interior of passageway 14. Each elongated conduit 52 is substantially parallel to, or is parallel to, axis of rotation 26a and/or axis of rotation 26b.

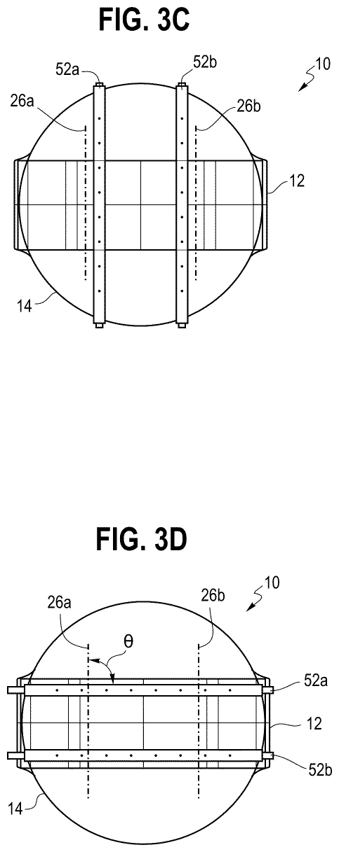

In an embodiment, each elongated conduit 52 includes a plurality of spaced-part ports 54 extending along the length of a downstream side of each elongated conduit 52. Ports 54 discharge, or otherwise dispense, the second fluid, along a length of each elongated conduit 52. In an embodiment, ports 54 discharge a continuous flow of the second fluid along a length of each conduit forming a fluidsheet. A “fluidsheet,” as used herein, is a substantially continuous, or a continuous, fluid body composed of the second fluid disposed in the FFS1, the body of the fluidsheet having a length, a width, and a height when the FFS1 is viewed from a cross sectional view downstream of the elongated conduit. FIG. 3A is a breakaway perspective view of apparatus 10 with passageway 16 and housing 18 removed. FIG. 3A showing fluidsheets 60a, 60b formed from respective injectors 50a, 50b (each having a respective elongated conduit 52 and spaced-apart ports 54). FIG. 3A shows each fluidsheet 60a, 60b having respective bodies 62a, 62b, each body 62a, 62b being a continuous volume of F2, each body 62a, 62b having respective dimensions of a length (L), and width (W), and a height (H).

FIG. 3C is a sectional view taken along line 3C-3C of FIG. 3A. FIG. 3C shows each elongated conduit 52a, 52b, one for each respective injector, injector 50a and injector 50b. In FIG. 3C, each elongated conduit 52a, 52b is substantially parallel to, or is parallel to, axis of rotation 26a and/or axis of rotation 26b as indicated by θ of 0° wherein θ is the angle relative to (i) the axis defined by each elongated conduit 52a, 52b and (ii) axis of rotation 26a and/or 26b.

FIG. 3D is a sectional view taken along line 3C-3C of FIG. 3A. FIG. 3C shows each elongated conduit 52a, 52b one for each respective injector, injector 50a and injector 50b. In FIG. 3C, each elongated conduit 52a, 52b is substantially perpendicular to, or is perpendicular to, axis of rotation 26a and/or axis of rotation 26b as indicated by θ of 90°.

Returning to FIG. 1, injectors 50 are located at a distance that is at least one-half of a gear diameter (or 0.5G_{d}) upstream of inlet 19. By way of example when gear 22a (and/or gear 22b) has a diameter of 32 cm, the distance of one-half gear diameter (or 0.5 G_{d}) is 16 cm. The process includes introducing second fluid 36 (interchangeably referred to as “F2”) into FFS1 34 at a distance that is at least one-half of a gear diameter, or 0.5G_{d}, upstream from inlet 19, or from 1 G_{d} to 5 G_{d}, or from 1 G_{d} to 3 G_{d}, or from 1.5 G_{d} to 3 G_{d} upstream of inlet 19. In an embodiment, apparatus 10 includes two injectors, first injector 50a and second injector 50b, injector 50a spaced apart from injection 50b along a passageway diameter 56, each injector 50a, 50b (and passageway diameter 56) located a distance at least 0.5G_{d} upstream from inlet 19 as shown in FIG. 1.

In an embodiment, injectors 50 are located a distance that is at least the inlet width, I_{w}, upstream of inlet 19. The process includes introducing second fluid 36 (interchangeably referred to as “F2”) into FFS1 34 at a distance that is at least 1 I_{w}, upstream from inlet 19, or from 1 I_{w} to 5 I_{w}, or from 1 I_{w} to 3 I_{w}, or from 1.5 I_{w} to 3 I_{w} upstream of inlet 19. In an embodiment, apparatus 10 includes two injectors, first injector 50a and second injector 50b, injector 50a spaced apart from injector 50b along a passageway diameter 56, each injector 50a, 50b (and passageway diameter 56) located a distance 1 I_{w} upstream from inlet 19 as shown in FIG. 1.

The process includes introducing the second fluid 36 (interchangeably referred to as “F2”) through the elongated conduits and into the FFS1, each elongated conduit 52 is substantially parallel, or is parallel to, axis of rotation 26a and/or axis of rotation 26b.

The process includes feeding the FFS1 and F2 into inlet 19 and mixing the F2 36 into the FFS1 34 in gear chamber 20. FFS1 34 and F2 36 enter gear chamber 20 from passageway 14. The counter-rotating gears 22a, 22b create a suction force at Area 4 entrapping, or otherwise drawing, FFS1 and F2 into gear chamber 20. As counter-rotation of gears 22a, 22b continues, FFS1 and F2 are stretched in a space 38 between teeth 24 and the inner wall of gear chamber 20 as shown by arrows M in FIG. 1. With further gear rotation, stretching continues and a squeezing force occurs in space 38, mixing F2 into FFS1. As teeth 24 from gear 22a engage (or re-engage) with teeth 24 from gear 22b at Area 5, the entrapped FFS2 that is mixed into FFS1 is expelled from gear chamber 20, out and through outlet 42 as a mixed fluid flowstream 40 (or “mFFS 40”). This “suction-stretch-squeeze-expel” cycle repeats as gears 22a, 22b continue counter-rotating, the suction force entrapping new quantities of FFS1 34 and F2 36 between intermeshing teeth and gear chamber inner wall, continuing the cycle.

The process includes discharging the mFFS 40 from the outlet 42. From outlet 42 mFFS 40 flows into outlet barrel 16 for further processing and/or handling.

In an embodiment, the process includes introducing the second fluid 36 (interchangeably referred to as “F2”) through the elongated conduits and into the FFS1, each elongated conduit 52 is substantially parallel to, or is parallel to, axis of rotation 26a and/or axis of rotation 26b at a distance that is at least one-half of a gear diameter, or 0.5G_{d}, upstream from inlet 19 (or at a location at least 1 I_{w} upstream of inlet 19).

Bounded by no particular theory, Applicant discovered the introduction of the second fluid into FFS1 by way of elongated conduits 52a, 52b (each having space-apart ports) that are substantially parallel to, or are parallel to (e.g., θ is 0°), (i) axis of rotation 26a and/or (ii) axis of rotation 26b unexpectedly improves the degree of mixing as evidenced by low COV values, particularly when compared to second fluid addition by way of elongated conduits that are not parallel to the gear axis. Applicant further discovered that introduction of the second fluid into FFS1 at a distance that is at least one-half of a gear diameter (or a distance that is at least one I_{w} upstream of inlet 19) unexpectedly creates, or otherwise defines, a recirculation zone in passageway 14 (or alternatively in the tapered section). A “recirculation zone,” as used herein, is a volume portion in passageway 14 (or a volume portion in the tapered section) with a downstream end defined by a plane encompassing inlet 19 and an upstream end defined by a plane encompassing elongated conduits located at least one-half of a gear diameter (0.5 G_{d}) away from, and upstream to, inlet 19 (or located a distance at least one I_{w} away from, and upstream to, inlet 19); the rotation of gears 22a, 22b creating in the volume portion (i) a laminar flow stream of FFS1 and the second fluid and (ii) a vortex flow stream of FFS1 and the second fluid. The recirculation zones perform two actions: (1) the recirculation zone moves the incoming second fluid sheets (F2) to a low-pressure zone at an apex of the gear intermeshing zone; and (2) the recirculation zone enhances the mixing of the second fluid sheets (F2), as a portion of the second fluid F2 initially mixes in the recirculation zone and then enters gear chamber 20.

In an embodiment, the process includes forming a laminar flow stream through gear chamber 20. A “laminar flow stream,” as used herein, is a flow where small disturbances in the form of eddies or vortices do not have energy sufficient to sustain; any eddies or vortices dissipate instantaneously; laminar flow inapposite to turbulent flow. The laminar flow stream includes a portion of FFS1 and a portion of F2 flowing through and around intermeshing gears 22a and 22b as shown by arrows M in FIGS. 1 and 2.

In an embodiment, the process also includes forming a vortex flow stream in the recirculation zone. A “vortex flow stream,” as used herein, is a flow stream in the recirculation zone where a portion of FFS1 and/or including a portion of F2 revolves around an axis to create a vortex. The recirculation zone (composed of FFS1 and F2) is located in the passageway, such that the downstream end of the recirculation zone borders with the top of the gear-teeth, the passageway sidewall borders another side and the recirculation zone upstream end is defined by the location of the injectors, the injectors being a distance at least 0.5G_{d} upstream from inlet 19 (or being a distance at least one I_{w} from inlet 19). The upstream end of the recirculation zone remains open to the viscous flow of FFS1 and FFS2 as shown by arrow 1 in FIG. 1. Gear-pump assembly 12 with two gears rotating in opposite direction to each other, creates two recirculation zones, with a separate and discrete vortex flow in each recirculation zone, each recirculation zone upstream of each respective gear 22a, 22b, as shown in FIG. 1 and in FIG. 3B.

In an embodiment, apparatus 10 includes a first injector 50a and a second injector 50b as shown in FIG. 3A. Each injector includes a respective elongated conduit 52 with respective ports 54 for discharging second fluid 36 as respective first flowsheet 60a and second flowsheet 60b into FFS1 34. First injector 50a is spaced apart a distance from the second injector. Injectors 50a, 50b are located at least one-half of a gear diameter, 0.5 G_{d}, upstream from inlet 19 (or are located a distance 1 I_{w} upstream from inlet 19), thereby defining a recirculation zone. The process includes introducing the second fluid from each respective elongated conduit (vis-à-vis ports 54) and forming respective first flowsheet 60a and second flowsheet 60b into the FFS1 at a location at least 0.5G_{d} (or at least one I_{w}) upstream of inlet 19. The process includes forming a first vortex flow 66a and a second vortex flow 66b in respective first recirculation zone 70a and second recirculation zone 70b as shown in FIG. 1. The process includes feeding FFS1 34 and flowsheets 60a, 60b into inlet 19; mixing, in gear chamber 20, second fluid 36 with FFS1 34 to form a mixed fluid flowstream 40 (mFF 40S); discharging mFFS 40 from outlet 42; and forming a mFFS 40 having a CoV from 0.001 to 0.8, or from 0.1 to 0.5.

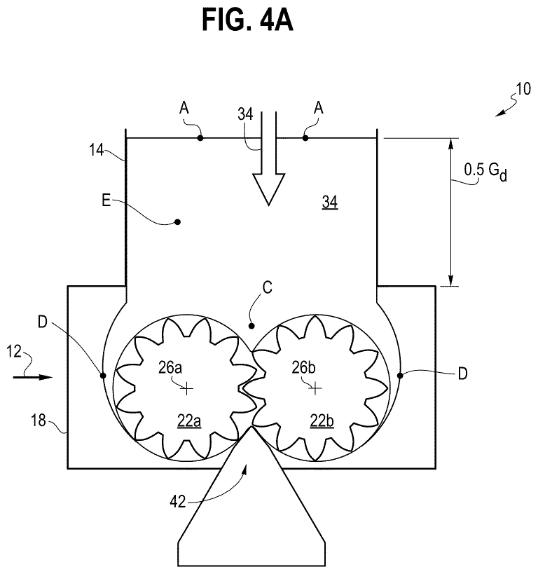

For evaluation purposes, FIGS. 4A-4E show apparatus 10 with injectors at different locations within passageway 14 and gear pump assembly 12. In FIG. 4A, location A indicates two injectors a distance 0.5G_{d} upstream of inlet 19. In FIG. 4A, elongated conduits are substantially parallel to, or are parallel to, axes of rotation 26a, 26b (θ of 0°) as shown in FIG. 3C. Location C indicates a single injector within gear chamber 20 at a distance less than 0.5G_{d} upstream to inlet 19. Location D indicates two injectors in gear chamber 20 at space 38 and a distance less than 0.5G_{d} upstream from inlet 19. Location E indicates a single injector in passageway 14 and a distance less than 0.5G_{d} upstream to inlet 19.

FIG. 4B shows a flow and mixing profile for two injectors at locations A in FIG. 4A, with cross-sectional view of mFFS 40 taken along line 4B-4B. Laminar flow M and vortex flow N form a mFFS with a CoV of 0.33. FIG. 4B with injectors at locations A is an example of the present disclosure.

FIG. 4C shows a flow and mixing profile for single injector at location C in FIG. 4A, with cross-sectional view of mFFS 40 taken along line 4C-4C. Laminar flow M and no vortex flow N form a mFFS with a CoV of 0.61. FIG. 4C with single injector at location C is a comparative sample of the present disclosure.

FIG. 4D shows a flow and mixing profile for two injectors at locations D in FIG. 4A, with cross-sectional view of mFFS 40 taken along line 4D-4D. Laminar flow M and no vortex flow N forms a mFFS with a CoV of 0.54. FIG. 4D with two injectors at locations D is a comparative sample of the present disclosure.

FIG. 4E shows a flow and mixing profile for a single injector at location E in FIG. 4A, with cross-sectional view of mFFS 40 taken along line 4E-4E. Laminar flow M and vortex flow N forming a mFFS with a CoV of 0.89. FIG. 4E with single injector at location E is a comparative sample of the present disclosure.

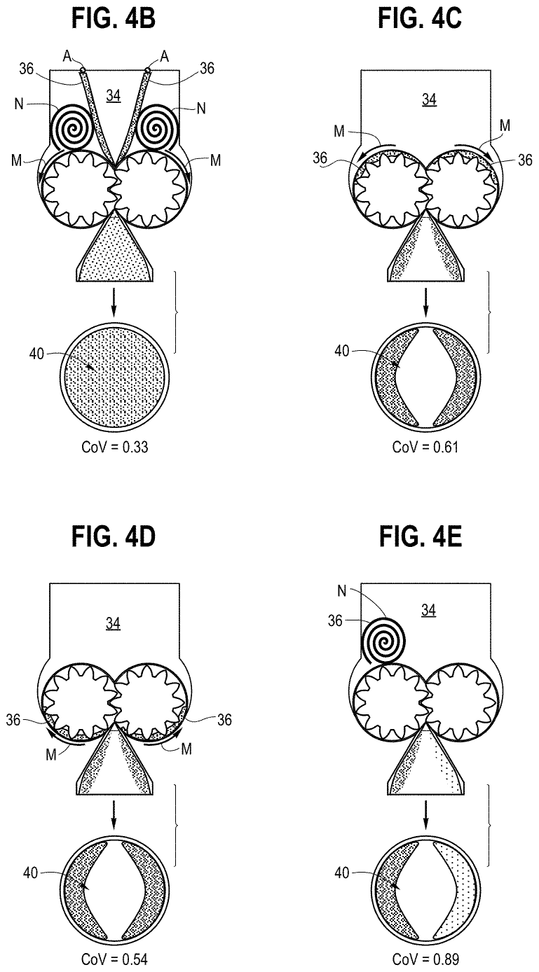

FIG. 5 shows an embodiment of apparatus 10 having a tapered section 15 in fluid communication with passageway 14 and located on an upstream side of gear assembly 12. Tapered section 15 is in fluid communication with gear chamber 20.

In an embodiment, apparatus 10 includes tapered section 15. Tapered section 15 is an annular body 28 with an upstream end 30 having a diameter that is greater than the length of the inlet width 21. Tapered section 15 has downstream end 32 having a diameter that is the length of the inlet width 21. In other words, the diameter of the downstream end 32 is the same as, or substantially the same as, inlet width 21.

Moving from the upstream end 30 to the downstream end 32, tapered section 15 has body 28 with a diameter that gradually reduces, or otherwise gradually diminishes, constricting the interior volume within tapered section 15. In this way, tapered section 15 has an upstream diameter that is greater than the inlet width which reduces to the downstream end having a diameter that is the same as, or substantially the same as, or less than, the inlet width. The constricted diameter of tapered section 15 increases the pressure in the fluid flow stream as the fluid flow stream enters gear chamber 20. In an embodiment, the process includes positioning the elongated conduits at the upstream end of the tapered section to be substantially parallel to, or parallel to, axis of rotation 26a, and/or 26b; introducing the second fluid from each respective elongated conduit into the FFS1 at a location at least one inlet width (I_{w}) upstream of the inlet, feeding the FFS1 and the second fluid into inlet 19; mixing, in the gear chamber, the second fluid with FFS1 to form a mixed fluid flowstream (mFFS); and discharging the mFFS from the outlet. In a further embodiment, the process includes forming a mFFS having a CoV from 0.1 to 0.5.

The present disclosure advantageously provides a process for mixing a second fluid (F2), such as an additive to a polymer melt stream (FFS1) without the use of extruders and static mixers. In an embodiment, the present process is accomplished by utilizing a liquid additive injector system that is placed in the conduit carrying polymer flow to the gear-pump. The present disclosure also provides specific gear profile to achieve effective mixing. The shear and mixing provided by the gear-pump is capitalized to achieve the desired mixing.

By way of example, and not by limitation, examples of embodiments of the present disclosure are provided below.

### EXAMPLES

Table 1 below provides materials used in the examples.

TABLE 1
materials

| | F2 (additive) | FFS1 LDPE (2MI, 0.92 g/cc) |
|---|---|---|
| Density g/cc | 0.720 | 0.720 |
| Viscosity cP | 1.0 | 1,000,000 |
| Temperature ° C. | 130 | 130 |
| Weigh fraction | 0.018 | 0.982 |

In an embodiment, an apparatus 100 is provided as shown in FIG. 1. Apparatus 100 is similar to apparatus 10 (disclosed above) wherein apparatus 100 includes additional and/or alternate components for evaluating mixing performance.

Elongated conduit 52 penetrates, or otherwise transverses, passageway 14 and extends across the interior of passageway 14. Elongated conduit 52 extends into the interior of the passageway. A plurality of spaced-part ports extend along the length of a downstream side of elongated conduit 52. Apparatus 100 may also include a source for F2, along with tubing, valve(s), and pump(s) for supplying F2 to elongated conduit 52. For apparatus 100, the distance between the axis of rotation 26a and elongated conduit 52 is 7.6 inches. For apparatus 100, outlet barrel 16 is 18 inches long.

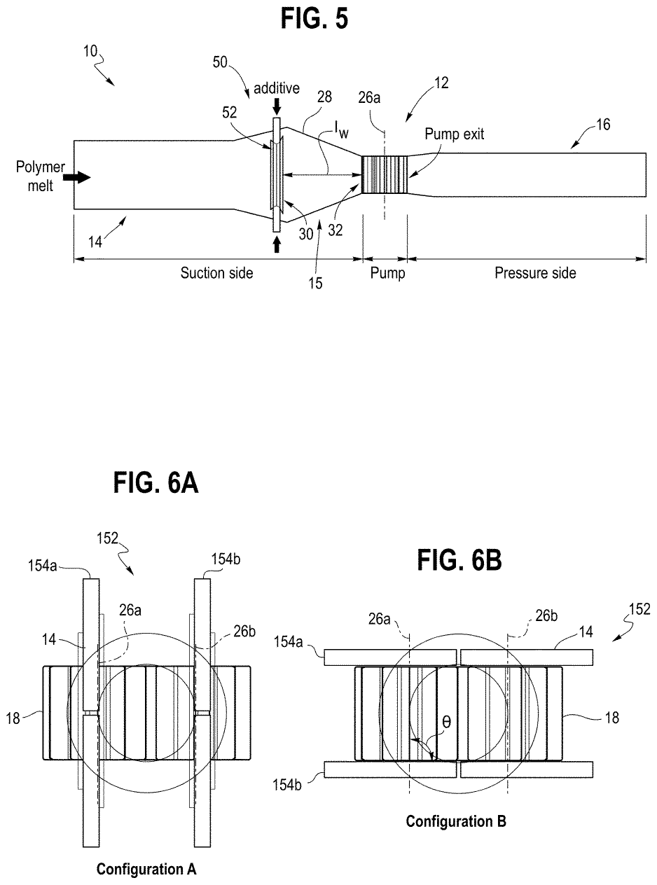

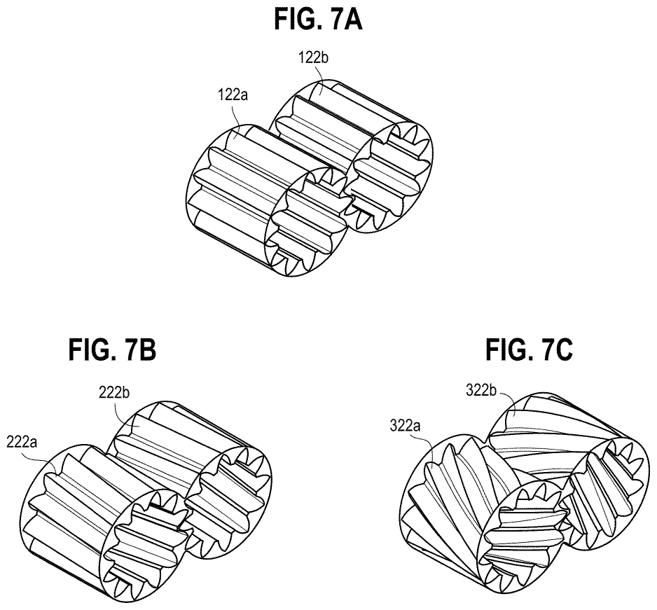

For evaluation purposes, an elongated conduit 152 is provided and includes two elongated conduits 156a, 156b spaced-apart and parallel to, or substantially parallel to, each other, as shown in FIGS. 6A-6B. Each elongated conduit 154a and 154b includes two 1-inch schedule 40 pipes with sixteen 3/16″ ports 156 (eight ports on each pipe), and each port is 3 inches apart. Ports 156 are on the downstream face of each elongated conduit 154a, 154b.

In configuration A, elongated conduits are vertically oriented in passageway 14, such that elongated conduit 154a and elongated conduit 154b each is parallel to, or is substantially parallel to, each axis of rotation 26a, 26b for respective gears 22a, 22b, as shown in FIG. 6A.

In configuration B, elongated conduits are horizontally oriented in passageway 14, such that elongated conduit 154a and elongated conduit 154b each is perpendicular to, or is substantially perpendicular to, each axis of rotation 26a, 26b for the gears, as shown in FIG. 6B.

In apparatus 100, the pitch diameter for each gear is 2.756 inch with a helix angle of 30°. In the gear chamber 20, both (i) the inter-teeth clearance and the (ii) clearance between the gear tip and the housing are maintained at 0.022 inch.

Table 2 below provides the CoV values for a cross-sectional plane of mFFS 40 is at outlet barrel 16. Computational Fluid Dynamics (CFD), a modeling approach is used to simulate flow through apparatus 100. CFD (Starccm+V15) and meshing tool (SCORG) are used to generate the CoV values in Table 2 below. CFD simulates the flow and mixing of the additive through the polymer melt and past the gear-teeth. The concentrations of the additive across the cross-sectional plane at the outlet are used to calculate the CoV based on the degree of mixing Equations 1-3 (CoV) described earlier.

The CoV values are calculated across a cross-section that is perpendicular to the flow stream. As mentioned earlier, the CoV calculates the ratio of standard deviation over the mean concentration of the second fluid (F2). The standard deviation and the mean concentration values are calculated based on CFD simulation results with the above mentioned operating conditions. The simulations are run to achieve steady state conditions when there are no more changes to the mean and standard deviations of the concentration values across different cross-sectional planes. Since CFD simulation retain the details of the velocity, pressure, temperature and concentration values at each computational cell, the standard deviation and mean concentration values at a given cross-section can be calculated.

TABLE 2
Mixing evaluation -- CoV values

| | COV |
|---|---|
| Configuration A (θ = 0°) | 0.1 |
| Elongated conduit | |
| Configuration B (θ = 90°) | 0.25 |
| Elongated conduit | |

Surprisingly, it was found that the CoV value for Configuration A was 0.1—significantly lower than the CoV value for the Configuration B which was 0.25. The lower the CoV value, the better the mixing. Configuration A provides more than 2× improvement in mixing over Configuration B.

It is specifically intended that the present disclosure not be limited to the embodiments and illustrations contained herein, but include modified forms of those embodiments including portions of the embodiments and combinations of elements of different embodiments as come within the scope of the following claims.

1. A process comprising:
providing an apparatus comprising
(A) a passageway with an interior for receiving a first flow stream (FFS1), the passageway having an inflow end and an opposing outflow end;
(B) a gear pump assembly comprising
(i) a housing,
(ii) a gear chamber in the housing,
(iii) an inlet placing the passageway outflow end in fluid communication with the gear chamber, the inlet having a width (I_{w}),
(iv) a plurality of intermeshing gears mounted for rotation in the gear chamber, the gears having teeth which engage with each other in the chamber, each gear having an axis of rotation, and
(v) an outlet in fluid communication with the gear chamber,
(C) one or more injectors upstream of the gear pump assembly for adding a second fluid into the first flow stream, the injectors located a distance of at least one-half of a gear diameter upstream of the inlet, each injector having an elongated conduit extending into the passageway interior, each elongated conduit substantially parallel to the gear axis of rotation;
the process comprising
introducing the second fluid from each respective elongated conduit into the FFS1 at a location at least one-half of a gear diameter upstream of the inlet;
feeding the FFS1 and the second fluid into the inlet;
mixing, in the gear chamber, the second fluid with FFS1 to form a mixed fluid flowstream (mFFS); and
discharging the mFFS from the outlet.

2. The process of claim 1 wherein the passageway comprises a recirculation zone defined by a passageway volume portion from the inlet and upstream a distance of at least one-half of a gear diameter the process comprising
forming a vortex flow of the FFS1 and F2 in the recirculation zone.

3. The process of claim 1 wherein each elongated conduit comprises a plurality of ports spaced apart along a length of each elongated conduit, the process comprising discharging the second fluid from the ports; and
forming a fluidsheet in the FFS1, the fluidsheet composed of the second fluid.

4. The process of claim 3 wherein the apparatus comprises a first injector and a second injector spaced apart along a diameter length of the passageway, each injector has a respective elongated conduit with a plurality of ports spaced apart along a length of each elongated conduit, each elongated conduit substantially parallel to the gear axis of rotation, the process comprising
forming a first fluidsheet in the FFS1 from the first injector and forming a second fluidsheet from the second injector;
forming, in the recirculation zone, a first vortex flow composed of a portion of the FFS1 and the first fluidsheet and forming a second vortex flow composed of a portion of the FFS1 and the second fluid.

5. The process of claim 1, wherein the passageway comprises a tapered section having an upstream end with a diameter greater than I_{w} and reducing to a downstream end having a diameter that is less than or equal to I_{w}, the process comprising
positioning the elongated conduits at the upstream end of the tapered section;
introducing the second fluid from each respective elongated conduit into the FFS1 at a location at least one inlet width (I_{w}) upstream of the inlet.

6. The process of claim 1 comprising forming a mFFS having a Coefficient of Variation from 0.001 to 0.8.
